(19) United States
(12) Patent Application Publication
(10) Pub. No.: US 2013/0334873 A1
(43) Pub. Date: Dec. 19, 2013

(54) SYSTEM AND METHOD TO RE-USE OR RECYCLE CLEAN ELECTRICITY FROM AN ELECTRICAL MOTOR

(71) Applicant: Abuanthony Abdul Alim, Daytona, FL (US)

(72) Inventor: Abuanthony Abdul Alim, Daytona, FL (US)

(21) Appl. No.: 13/523,879

(22) Filed: Jun. 14, 2012

(51) Int. Cl. B60L 11/18; H02K 53/00

(52) U.S. Cl. 307/9.1; 74/DIG. 9

(57) ABSTRACT

A system and method that can generate and regenerate electricity from a vehicle having an 37 Electrically operable drive motor, 27 mechanical electric drive shaft, 29 mechanical electric wheel Axle and 31 mechanical electric wheels and or 33 mechanical electric vehicle attachment and or a 35 mechanical electric vehicle trailer. The vehicle could be designed to restore all, the electricity it used. By connecting the 27 mechanical electric drive shaft, 29 mechanical electric Wheel Axle and the 31 mechanical electrical wheels to the vehicle's inverter and store it in batteries. An inverter can be used to send that power to the 37 motor when needed. In some embodiments; excess Power can be output from the vehicle for utilities.

### BACKGROUND OF THE INVENTION

The present invention relates to energy storage and conservation and more particularly, to a system and method to re-use or recycle clean electricity from an electrical motor.

Currently, steps have been made to develop electric vehicles, such as electric cars and the like. However, these vehicles often use more power than they could generate during use. Moreover, these vehicles often have an internal combustion engine for additional power and/or electricity generation. With conventional vehicles, the electricity is used and has to be regenerated with fossil fuel power plants.

As can be seen, there is a need for a system and method for reusing or recycling clean electricity from an electrical motor in a vehicle.

### SUMMARY OF THE INVENTION

In one aspect of the present invention, a energy system for a vehicle comprises an electric motor adapted to drive the vehicle via at least one of a drive shaft and a wheel axle; at least one transfer case receiving rotation input from at least one of the drive shaft and the wheel axle; at least one generator receiving rotation output from the at least one transfer case; and at least one energy storage device receiving power output from the generator.

In another aspect of the present invention, an energy system comprises an electric motor adapted to drive the vehicle via at least one of a drive shaft and a wheel axle; at least one transfer case receiving rotation input from at least one of the drive shaft and the wheel axle; at least one generator receiving rotation output from the at least one transfer case; at least one energy storage device receiving power output from the generator; and an inverter to convert power generated by the at least one generator to power usable to power the electric motor, wherein the at least one energy storage device includes one or more batteries, the at least one energy storage device includes an electric flywheel storage, and at least two generators are connected to receive rotation output from the same transfer case.

These and other features, aspects and advantages of the present invention will become better understood with reference to the following drawings, description and claims.

### BRIEF DESCRIPTION OF THE DRAWINGS

FIG. 1 is a system schematic of an energy system for use in a car/truck/bike configuration according to an exemplary embodiment of the present invention;

FIG. 2 is a system schematic of an energy system for use in an aircraft configuration according to an exemplary embodiment of the present invention;

FIG. 3 is a system schematic of an energy system for use in a multiple axle truck configuration according to an exemplary embodiment of the present invention;

FIG. 4 is a system schematic of an energy system for use in a locomotive configuration according to an exemplary embodiment of the present invention;

FIG. 5 is a system schematic of an energy system for use in a locomotive configuration according to another exemplary embodiment of the present invention;

FIG. 6 is a system schematic of an energy system for use in a locomotive configuration according to another exemplary embodiment of the present invention; and

FIG. 7 is a system schematic of an energy system for use in a locomotive configuration according to a further exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system and method of generating electricity from a vehicle having an electrically operable drive and motor. The vehicle could be designed to restore all the electricity it used. By connecting the vehicle's drive shaft to a transfer case and/or a torque converter with smart, two-way generators or single generators, the vehicle can produce electricity and store it in batteries. An inverter can be used to send that power to the motor when needed. In some embodiments, excess power can be output from the vehicle for utilities. No known machine uses the mechanical energy of a vehicle to generate its own electricity as is done with the present invention.

The system and method of the present invention can reduce or eliminate the use of fossil fuels in vehicles and for electricity generation, freeing people of the need to pay for petroleum and/or foreign oil. The vehicles of the present invention can be designed to create a vehicle that can create the power they need for use. The vehicle using the system and method of the present invention can be a car, truck, bike, locomotive, aircraft, and the like.

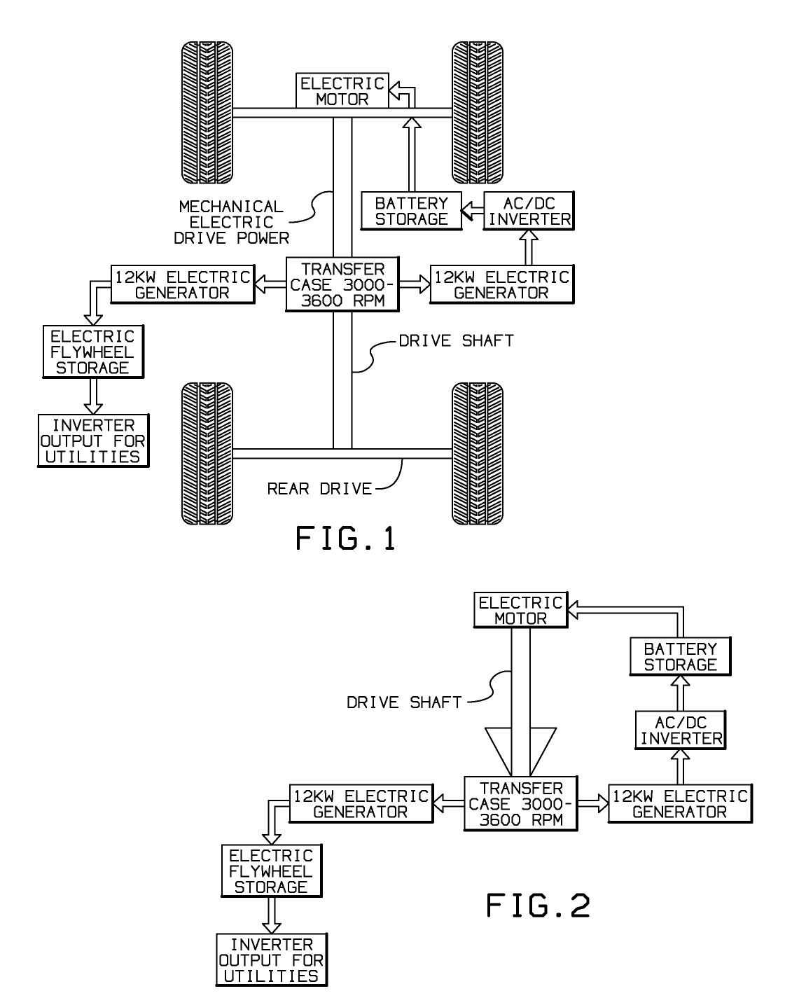

Referring now to FIG. 1, a car/truck/bike configuration of an energy system may include an electric motor on a vehicle to drive wheels of the vehicle. The drive shaft of the vehicle can include a transfer case that is typically turned at 3000-3600 revolutions per minute (rpm). The transfer case may be a torque converter, for example. The transfer case can drive an electric generator which can, via an AC/DC inverter, store energy in a battery to be available for the electric motor. The transfer case can also drive an electric generator that can store generated electricity in an electric flywheel. This power can be used for utilities as needed, for example. The electric generators may be designed in various sizes, depending on application. In an exemplary embodiment, the electric generators may be 12 kilowatt (kW) generators.

Referring to FIG. 2, an aircraft configuration of an energy system is shown. This configuration can be very similar to the car/truck/bike configuration, where a drive shaft may, via a transfer case, drive one or more generators, where a generator may create power for battery storage and/or electric flywheel storage, for example.

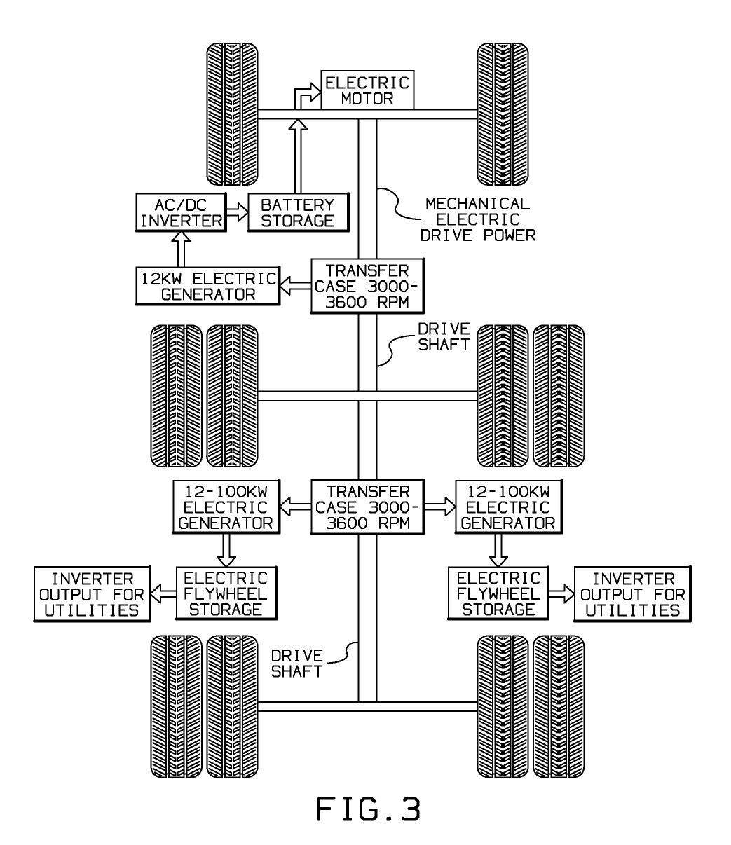

Referring to FIG. 3, a multiple axle vehicle configuration of an energy system is shown. With multiple axles, multiple drive shafts interconnect the multiple axles, providing regions for multiple transfer cases to be used to generate rotational power to drive a plurality of generators. Similar to the car/truck/bike configuration, the multiple axle vehicle configuration can generate power for driving the electric motor as well as generating power for electric flywheel storage and eventual output for utilities, for example.

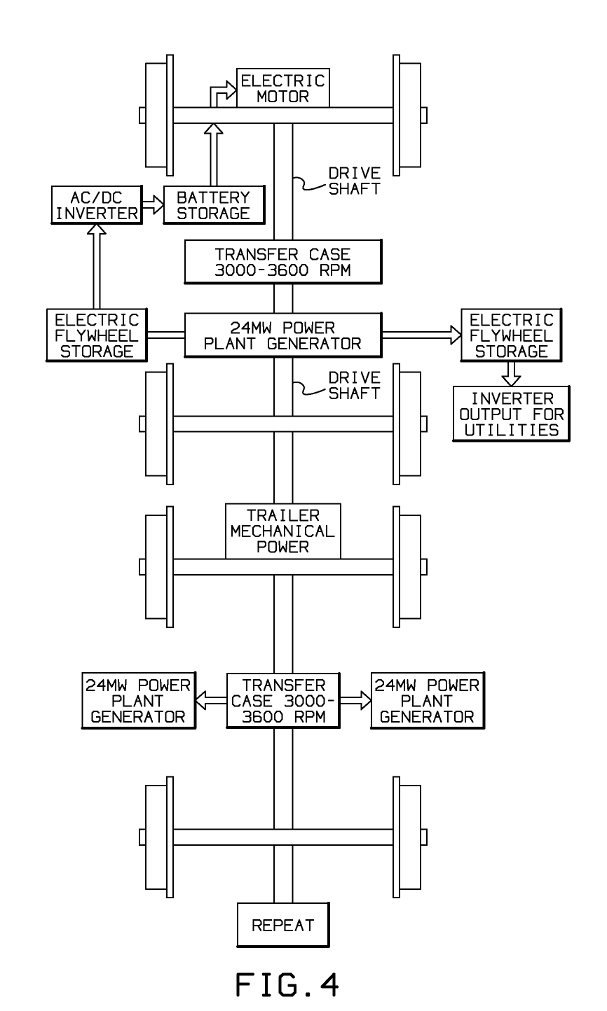

Referring to FIG. 4, a locomotive configuration for an energy system is shown. The locomotive configuration can be similarly designed as the multiple axle vehicle configuration. With the locomotive configuration, the generators may be larger, such as 24 megawatt (MW) generators. These generators may be directly connected to the drive shaft or may be connected to a transfer case, depending on the application. Similar to the above embodiments, the power generated may be used for driving the electric motor and/or for being stored in an energy storage device, such as a battery, electric flywheel, or the like.

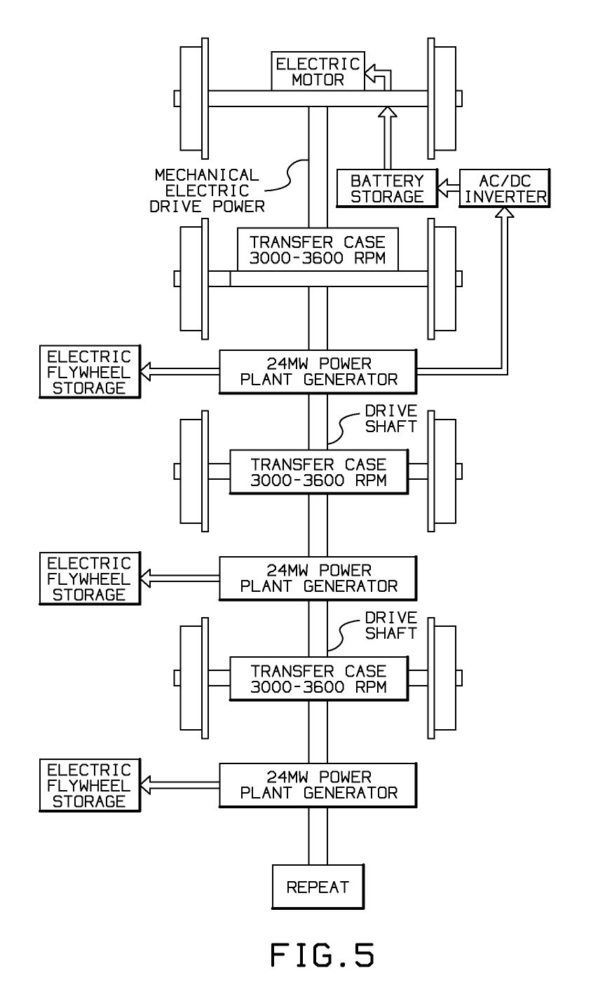

Referring now to FIG. 5, an alternate embodiment of the locomotive configuration of FIG. 4 is shown. In this embodiment, in addition to the design of FIG. 4, the embodiment of FIG. 5 can include transfer cases not only on the drive shaft, but also on wheel axles of the locomotive. This configuration may take advantage of multiple rotating shafts (drive shaft and wheel axles) to provide power to generators.

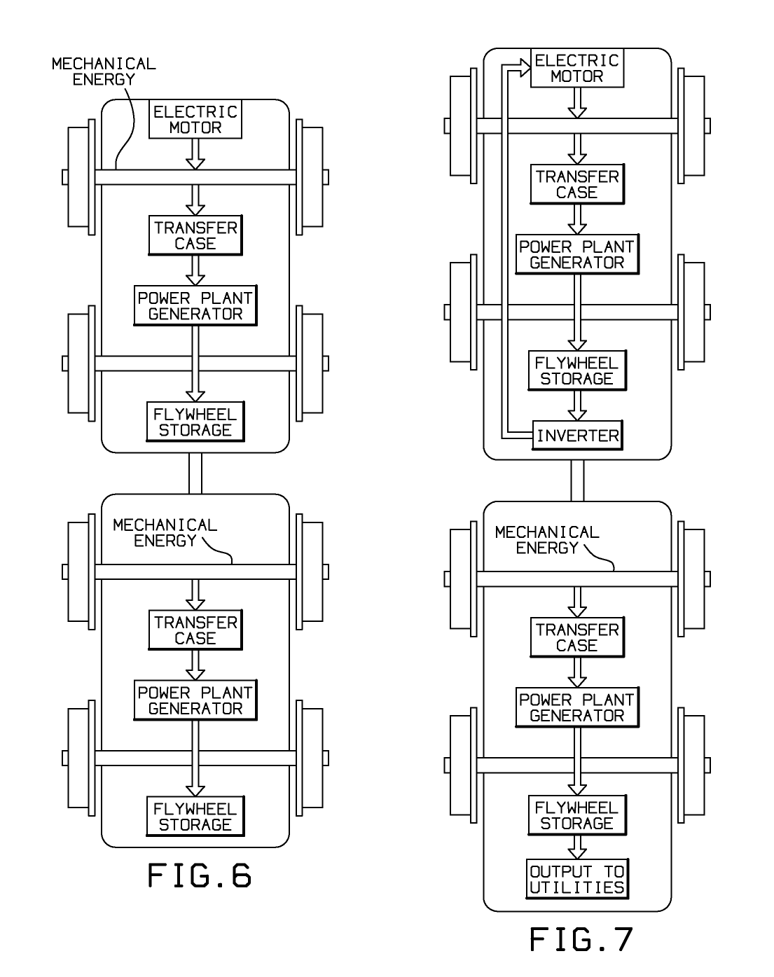

Referring to FIGS. 6 and 7, alternate embodiments of locomotive configurations are shown. In these embodiments, the electric motor may turn a wheel axle connected to wheels in an engine car of the locomotive. The mechanical energy of the wheel axle may be converted to power, and, as shown in FIG. 7, the power may be delivered back to the electric motor via an inverter. In other cars of the locomotive, mechanical energy from the wheel axles (driven axles, driven by the drive axle of the engine) may be converted to power and that power may be stored in flywheel storage and/or output to utilities.

For a locomotive, overhead power lines, or power connectors at various stops, for example, may be used to receive excess power generated by the locomotive. This energy release system may minimize the size needed for energy storage devices.

While the above describes the use of batteries and electric flywheels for storing power, other mechanism may be employed within the scope of the present invention to store power. For example, capacitors may be used to store energy.

While the above refers to specific vehicles (cars, trucks, bikes, aircraft, locomotives), other vehicles that may have an electric motor turning a drive shaft or powering a wheel axle could benefit from the system and methods of the present invention.

It should be understood, of course, that the foregoing relates to exemplary embodiments of the invention and that modifications may be made without departing from the spirit and scope of the invention as set forth in the following claims.

1. The first OPEN energy system for a vehicle wherein no fossil fuels to be used of any kind Comprising of:
A 37 electric motor adapted to drive the vehicle via at least one set of gears receiving rotation output From 37 electric motor which in turn rotates the 27 mechanical electric drive shaft and or a 29 Mechanical electric wheel axle; At least one 31 mechanical electric wheel receiving rotation output from The at least One gear set and or at least one energy storage device receiving power output from the 27 mechanical electric drive shaft and or the 29 mechanical electric wheel axles or at least one 31 mechanical electric wheels.

2. The energy system of claim 1 is the first working Open thermodynamic system for vehicles that will Advance vehicle transportation by using up to 90% of all kinetic energy created by a vehicle to convert to clean electricity using the drive shaft, wheel axles and wheels as generators harnessing kinetic energy.

3. The energy system of claim 1, wherein at least one 27 mechanical Electric drive shaft and or the 29 mechanical electric wheel axles or At least one 31 mechanical electric wheel connected to receive rotation output from the same 37 electric motor.

4. The energy system of claim 1, wherein at least one 27 drive shafts, 29 wheel axles and 31 wheels and or generators are connected to receive rotation output from the same transfer case or gears sets.

5. The energy system of claim 1, further comprising an inverter to convert power generated by the At least one 27 mechanical electric drive shaft and Or the 29 mechanical electric wheel axle; at Least one 31 mechanical electric wheel for power usable to power the 37 electric motor and or storage for batteries and or flywheel storage and or output to utilities or grids.

6. The energy system of claim 1, further comprising gears sets Receiving rotation input from a 27 mechanical electric drive shaft, and more Gears sets giving Rotation output to a 29 mechanical electric wheel axles as needed to supply power to Convert by inverter for the motor.

7. The energy system of claim 1, wherein the vehicle is a multiple 29 mechanical electric wheel axle Vehicle such as a truck or locomotive. Which makes for multiple places To generate clean electricity by using every 27 dive shaft, 29 wheel axle and wheels as generators collecting kinetic energy and converting it to clean electricity.

8. The energy system of claim 7, wherein the vehicle is a multiple 29 mechanical electric wheel axle Vehicle such as a truck or locomotive. Which will makes for multiple places To generate clean electricity by using every 27 dive shaft, 29 wheel axle and 31 wheels as generators collecting kinetic energy and converting it to clean electricity.

9. The first Open thermodynamic energy system for vehicles comprising:
An 37 electric motor adapted to drive the vehicle via at least one of a 27 Mechanical electric drive shaft. Which will output rotational forces to turn a 29 mechanical electric wheel axle and or 31 Mechanical electric Wheels to generate power to Supply at least one energy storage device receiving power output from the 27 mechanical electric drive shaft and or the 29 mechanical electric Wheel axle and have an inverter to convert power generated to power usable to power the 37 electric motor, wherein: The at least one energy storage device includes one or more Batteries, the at least one energy storage device includes an output system for flywheel Storage and or output to utilities.

10. The energy system of claim 10, wherein the vehicle use no fossil fuels for propulsion and is a Multiple axles Vehicle.

11. The energy system of claim 1, wherein the vehicle is any vehicle with 31 wheels, 27 Drive shafts and 29 wheel axles and or attachments and or trailers and or propellers in air or water That is upgraded to power generator systems as these inventions.

12. The energy system of claim 11, wherein the combination of components such as 27 drive shafts, 29 wheel axles and 31 wheels would create as much electric as a power plant sized generator.

13. An energy system comprising:
an electric motor adapted to drive the vehicle via at least one of a 27 drive shaft and a 29 wheel axle; at least one transfer case receiving rotation input from at least one of the 27 drive shaft and the 29 wheel axle; or at least one generator receiving rotation output from the at least one transfer case; at least one energy storage device receiving power output from the 27 drive shaft and the 29 wheel axle and or 31 wheel or a generator; and an inverter to convert power generated by the at least one 27 drive shaft and the 29 wheel axle and or 31 wheel or a generator to power usable to power the electric motor, wherein:
the at least one energy storage device includes one or more batteries, the at least one energy storage device includes an electric flywheel storage, and at least one 27 drive shaft and or the 29 wheel axle or wheel or a generator are connected to receive rotation output from the same transfer case or gear sets.

14. The energy system of claim 1, Wherein the vehicle could include multiple 37 mechanical electric 3 phase motors can act as generators or a motor and or a transmission as well a shaft driver when connected in vehicle.

15. The energy system of claim 14, wherein multiple 27 drive shaft and the 29 wheel axle and or 31 wheels and or transfer cases are disposed along the 27 drive shaft of the multiple axle vehicle.

16. The energy system of claim 15, wherein at least one 27 drive shaft and the 29 wheel axle and or 31 wheels and or transfer cases are disposed on a 29 wheel axle of the multiple axle vehicle.

17. The energy system of claim 1, wherein the vehicle is a locomotive or any vehicle that use electricity.

18. The energy system of claim 17, wherein the locomotive includes multiple 27 drive shafts and the 29 wheel axles and or 31 wheels and or transfer cases or gear sets disposed on multiple cars of the locomotive.

19. The energy system of claim 1, wherein the first Open thermodynamic system for a vehicle to be introduced as the example of every Open thermodynamic system to follow.
The definition of an open thermodynamic system assumes that there are supplies of energy that Cannot be depleted; in practice, this energy is supplied from some source in the surrounding environment, which can be treated as infinite.
The Closed thermodynamic systems for vehicles use the drive shafts and wheel axles and the wheels to Deplete the fossil fuel supply. In contrast the Open thermodynamic system for vehicles use the 27 Mechanical electric harness drive shaft system which generates electricity as well as the 29 mechanical Electrical harness wheel axles as well as the 31 mechanical electric harness wheels
To fully supply any and all energy need without the use of fossil fuels and or supply batteries with storage Power and or output for flywheel storage and or output to utilities or grids.
